(19) United States
(12) Patent Application Publication
(10) Pub. No.: US 2009/0307617 A1
(43) Pub. Date: Dec. 10, 2009

(54) System and Method For Providing Static Electric Display

(75) Inventors: David Christopher Howe, Derry, NH (US); Scott Adams, Wellesley, MA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: BrandPartners, Rochester, NH (US)

(21) Appl. No.: 12/133,047

(22) Filed: Jun. 4, 2008

(51) Int. Cl. G06F 3/048

(52) U.S. Cl. 715/764

(57) ABSTRACT

A system for remotely managing and causing display of changeable information on an semi-static electronic display element includes a data entry device having a user interface, configured for allowing a user to enter one of more pieces of changeable information. A changeable information receiving device is located remotely from the data entry device, and electronically coupled to the remotely located data entry device, and configured for receiving and storing the entered one or more pieces of changeable information received from the data entry device. A changeable information display device, including a display element and preferably battery operated, is located in relatively close proximity to the remotely located changeable information receiving device, and configured, in a first mode, for wirelessly receiving the remotely entered changeable information from the receiving device, and for causing the display element to display the received, user entered changeable information, and configured in a second mode for periodically interrogating or awaiting receipt of the changeable information from the receiving device, and configured, in a third mode, for entering a sleep or very low power consumption mode.

### TECHNICAL FIELD

The present invention relates to changeable displays and more particularly, to a system and method for remotely effectuating a change to a semi-static, electronic display element.

### BACKGROUND INFORMATION

In various retail establishments, it is not only desirable but necessary to frequently change information that is displayed to consumers. For example, banks, mortgage companies and saving institutions must update their loan, CD, mortgage and/or interest rates on at least a weekly and sometimes daily basis. The same holds true for other retail establishments in which prices of goods or services change frequently, such as establishments selling gasoline and other petroleum-based products.

What typically is done in these establishments is that the product offering cost or amount is managed through a static graphic that is typically printed or screened and changed locally when there is a price adjustment, a user must physically replace individual numbers, signs, placards or the like with the new individual numbers, signs, placards or the like. This is obviously labor-intensive and prone to error either in getting new information on the display or presenting incorrect information.

Some prior art attempts have been made at providing display information electronically. This information may be transmitted or pushed to the retail establishment using satellite signals. Such devices, however, require direct electricity to operate, are backlit solutions that are harder to read in direct sunlight, display moving dynamic information and therefore cannot always be located in an appropriate or desired space to be viewed by potential customers and not optimal for static imagery.

Accordingly, what is needed is a display system through which long life, battery-operated display devices can be utilized to display changeable information and wherein the changeable information can be wirelessly transmitted to the display device from a central receiver, which in turn receives new information from a data entry device accessible to a user. However, it is not entirely necessary to run on battery-life alone as traditional power sources for the display devices, if available, can also be utilized.

### SUMMARY

The present invention features a system for remotely managing and causing display of changeable information on an electronic display element. The system comprises a data entry device including a user interface, configured for allowing a user to enter one of more pieces of changeable information. The data entry device includes a data storage element, for storing the entered changeable information.

The system according to the present invention also includes a changeable information receiving device, located remotely from the data entry device, and electronically coupled to the remotely located data entry device, and configured for receiving and storing the entered one or more pieces of changeable information received from the data entry device. A changeable information display device is also provided. The display device includes a semi-static display element. The display device is disposed in relative close proximity to the remotely located changeable information receiving device and configured, in a first mode, for wirelessly receiving the remotely entered changeable information from the receiving device, and for causing the display element to display the received, user entered changeable information. The display device is also configured in a second mode, for periodically interrogating or awaiting receipt of the changeable information from the receiving device, and also configured, in a third mode, for entering a sleep or very low power consumption mode while maintaining a display of the user entered changeable information.

In the preferred embodiment, the changeable information display device is battery operated. The battery operated display device may also include a solar energy receiving mechanism, for charging batteries powering the display device. In other embodiments, the changeable information display device can be powered by traditional sources, or it can solar energy operated.

The changeable information display device may be configured, in a fourth mode, for determining that the battery operating the display device is in a low voltage condition, and for causing the display element to display a predetermined indicia indicating a low battery condition.

The user interface of said data entry device preferably includes a Web portal, while the data entry device includes one or more templates, the one or more templates including display font and/or image selections, for allowing the user entered one or more pieces of changeable information to be entered and viewed in a predetermined format. The predetermined format is preferably the same format as the changeable information will be displayed on the display element of the display device.

Further, the remotely located changeable information receiving device is coupled to the World Wide Web, for receiving the changeable information entered by the user on the data entry device.

Preferably, the changeable information display device is mounted to a display board having graphical information arranged on the display board around and in close proximity to the battery operated changeable information display device.

The display element of the battery operated changeable information display device may display the user entered changeable information utilizing electronically changeable charge carrying ink.

### BRIEF DESCRIPTION OF THE DRAWINGS

These and other features and advantages of the present invention will be better understood by reading the following detailed description, taken together with the drawings wherein:

FIG. 1 is block diagram of a system implementing the present invention;

FIG. 2 is a schematic drawing of a display incorporating a battery-operated changeable information display device in accordance with the present invention; and

FIG. 3 is an example of a user interface on a data entry device in accordance with one aspect of the present invention.

### DETAILED DESCRIPTION OF THE PREFERRED EMBODIMENTS

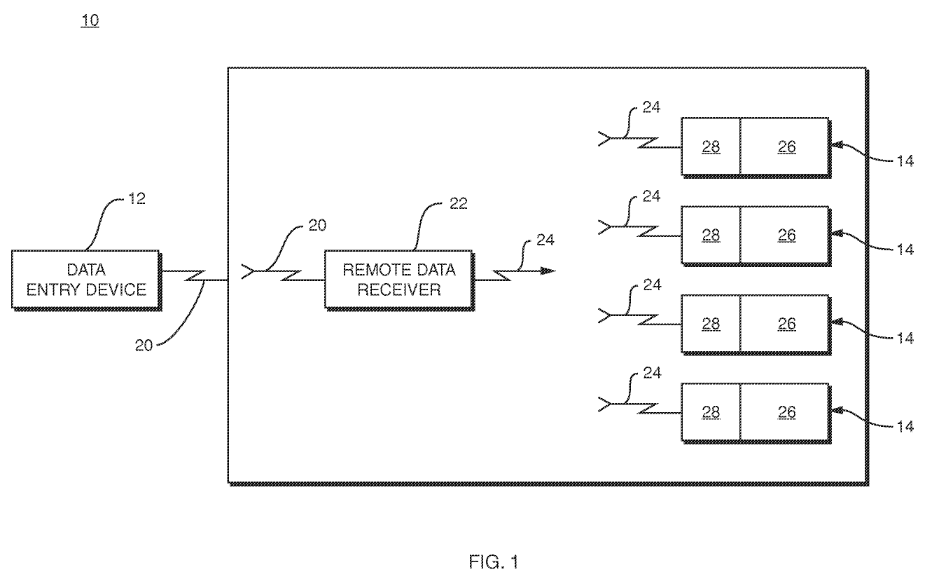

The present invention features a system 10, FIG. 1, for remotely managing and causing display of changeable information. In accordance with the present invention, an authorized user utilizes a data entry device 12 to enter information that is to be displayed on one or more remote display devices 14 located at a remote location 16 such as a bank, store or other retail establishment.

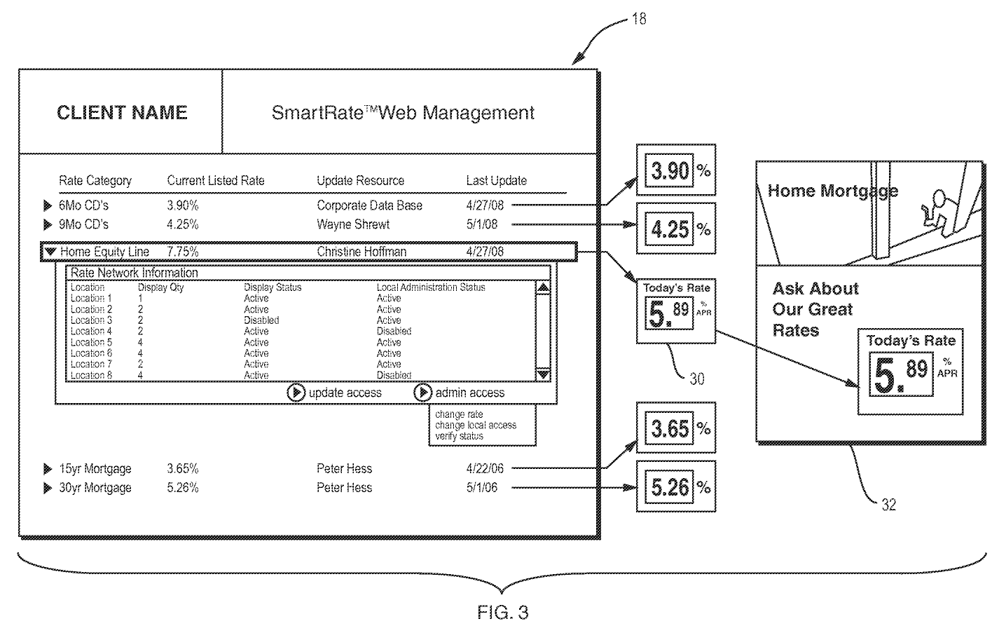

Using an appropriately designed user interface 18, FIG. 3, a user enters the appropriate changeable information. For purposes of explaining the present invention, information related to the banking industry will be used, although this is not a limitation of the present invention. Accordingly, an appropriate bank employee will utilize user interface 18 to enter various changeable information such as home mortgage or equity line interest rates, other loan rates, various CD rates and the like. In addition, the user interface may directly receive information from an external source such as a corporate wide database or an external data feed.

In the preferred embodiment, the user interface 18 will be a Web portal running on the data entry device 12 connected to the World Wide Web 20. Once this information is entered on the Web portal, it is available to each and every remote data receiver 22 remotely located at various remote locations 16 by virtue of the data receiver's 22 connection to the World Wide Web 20.

The remote data receiver 22 includes appropriate computer hardware and software as is well known in the art, to allow it to connect to the World Wide Web 20, receive and store user entered changeable information and, as will be explained in greater detail below, push or transmit the changeable information 24 to each display device 14 within range. In the preferred embodiment, it is contemplated that one remote data receiver 22 can be utilized to wirelessly transmit information to multiple local display devices 14 located within a range of approximately 10 to 100 meters using technology such as, but not limited to, Bluetooth® technology.

Each of the display devices 14 include any electronically operable semi-static display element 26, as well as appropriate hardware and software 28 which will be explained in greater detail below. In the preferred embodiment, the electronically operable display elements 26 are a type of electronically operable display element that are semi-static, that is, that are “set” electronically, but once set, power can be removed and the image will remain (i.e. become static), thereby significantly conserving battery life (if battery powered) and insuring that the display devices 14 can be deployed for periods of one year or more without having to have their batteries changed.

The display device, although preferably battery powered, may also be powered by standard wall current, if available, by solar power (which may be used to charge rechargeable batteries within the display device 14), or by other means of providing sufficient power to and as required by the display device 14.

The preferred embodiment contemplates that one advantageous display element 26 is electronic ink available from E INK Corporation of Cambridge, Mass. Electronic ink is an ink that carries a charge enabling it to be updated using electronics. Once “set” power can be removed and the electronic ink will stay in that condition for a long period of time. Electronic ink is typically contained in a paper-like medium providing high contrast with ultra low power consumption. Other display elements that are electronically settable and require little or no power to remain “set” are also contemplated and considered to be within the scope of the present invention.

Each display element 14 also includes appropriate software and hardware 28 to allow each display device 14 to wirelessly receive changeable information 24; to cause the changeable information 24 to the “set” on the display element 26 and to enter an appropriate mode or modes which causes the display device 14 to enter a “sleep” mode while periodically (at some predetermined interval such as, for example, once per week, once per day, or once per hour) “awaken” and poll or interrogate the remote data receiver 22 to determine if there is any new, changeable information 24 to be downloaded and displayed. If device 28 determines that information 24 in the remote data receiver 22 is different than the current information in the display, it will download and display the new information. Alternatively, the remote data receiver 22 may contain the requisite processing power and appropriate hardware an software to determine if the display device 14 contained the most up to date information 24 and if not, force a download of the changed information to the display device 14.

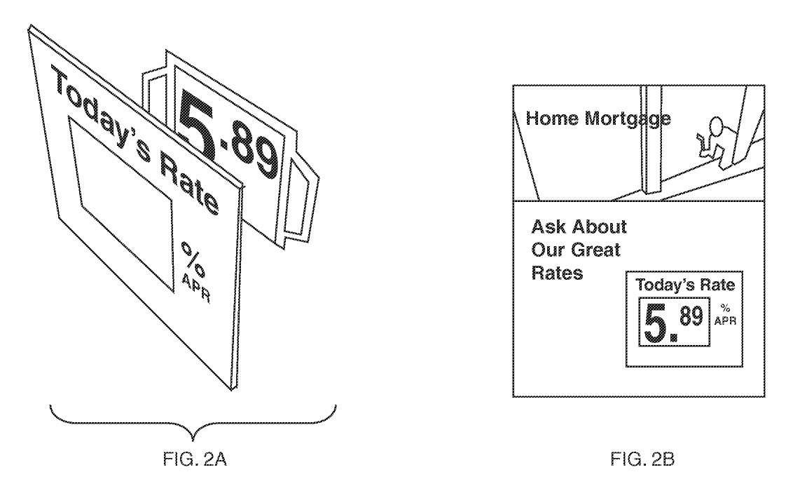

The present invention is particularly useful in combination with a static, printed display which surrounds or is otherwise used in connection with the display devices 14 which form part of the system according to the present invention. As shown in FIG. 2a, a battery-operated display device 14 can be used or integrated with a static, pre-printed graphic element 30 to provide, in combinations, a dynamically changeable and updatable display 32, FIG. 2b, incorporating both a pre-printed graphic display and the dynamically changeable display device 14. Such a graphic display 32 provides a very effective display for consumers, yet is portable, requires no hard wiring (can be hung on walls or windows where no electrical outlets exist) and can be managed remotely to control information across a large network without error or user intervention at each display graphic.

The display device 14 may be attached to a graphic element 30 in a variety of ways including, but not limited to magnetics, hook/loop fasteners.

The present invention is not to be limited by any preferred or exemplary embodiments. The enclosed embodiments are used to present an understanding of the present invention as currently contemplated by the inventor's. Modifications and substitutions by one of ordinary skill in the art are considered to be within the scope of the present invention, which is not to be limited except by the allowed claims and their legal equivalents.

The invention claimed is:

1. A system for remotely managing and causing display of changeable information on an electronic display element, said system comprising:
a data entry device including a user interface, configured for allowing a user to enter one of more pieces of changeable information, said data entry device including a data storage element, for storing said entered changeable information;
a changeable information receiving device, located remotely from said data entry device, electronically coupled to said remotely located data entry device, configured for receiving and storing said entered one or more pieces of changeable information received from said data entry device; and
a changeable information display device, said display device including a display element, said display device disposed in relatively close proximity to said remotely located changeable information receiving device, said display device configured, in a first mode, for wirelessly receiving said remotely entered changeable information from said receiving device, and for causing said display element to display said received, user entered changeable information, and configured in a second mode for periodically interrogating or awaiting receipt of said changeable information from said receiving device, and configured, in a third mode, for entering a sleep or very low power consumption mode while maintaining a display of said user entered changeable information.

2. The system of claim 8, wherein said changeable information display device is configured, in a fourth mode, for determining that said battery operating said display device is in a low voltage condition, and for causing said display element to display a predetermined indicia indicating a low battery condition.

3. The system of claim 1, wherein said user interface of said data entry device includes a Web portal.

4. The system of claim 3, wherein said data entry device includes one or more templates, said one or more templates including display font and/or image selections, for allowing said user entered one or more pieces of changeable information to be entered and viewed in a predetermined format, said predetermined format being the same format as said changeable information will be displayed on said display element of said display device.

5. The system of claim 3, wherein said remotely located changeable information receiving device is coupled to the World Wide Web, for receiving said changeable information entered by said user on said data entry device.

6. The system of claim 1, wherein said changeable information display device is mounted to a display board having graphical information arranged on said display board around and in close proximity to said battery operated changeable information display device.

7. The system of claim 1, wherein said display element of said battery operated changeable information display device displays said user entered changeable information utilizing electronically changeable charge carrying ink.

8. The system of claim 1 wherein said changeable information display device is battery operated.

9. The system of claim 8 wherein said battery operated display device includes a solar energy receiving mechanism, for charging batteries powering said display device.

10. The system of claim 1 wherein said changeable information display device is solar energy operated.
